(19) United States
(12) Patent Application Publication
(10) Pub. No.: US 2011/0279407 A1
(43) Pub. Date: Nov. 17, 2011

(54) CIRCUIT FOR PROCESSING TOUCH LINE SIGNAL OF TOUCH SCREEN

(75) Inventors: Ji-Hun KIM, Daejeon-si (KR); Young-Bok Kim, Busan-si (KR); Joon-Ho Na, Daejeon-si (KR); Yeong-Shin Jang, Daejeon-si (KR); Sang-Gug Lee, Daejeon-si (KR)

(73) Assignee: SILICON WORKS CO., LTD., Daejeon-si (KR)

(21) Appl. No.: 13/105,301

(22) Filed: May 11, 2011

(30) Foreign Application Priority Data
May 13, 2010 (KR) 10-2010-0044817

(51) Int. Cl. G06F 3/044

(52) U.S. Cl. 345/174

(57) ABSTRACT

A circuit for processing a touch line signal of a touch screen includes a plurality of sensing read circuits and a switch unit. The plurality of sensing read circuits include sensing read-out units and integrators, respectively. The sensing read-out units are configured to precharge a first sensor capacitor and a second sensor capacitor formed on a touch screen panel with a ground voltage and a supply voltage, allow charges charged in the first sensor capacitor and the second sensor capacitor to be shared, and read-out a charge sharing result obtained by allowing the charges of the first sensor capacitor and the second sensor capacitor to be shared. The integrators are configured to integrate output voltages of the sensing read-out units. The switch unit is configured to sequentially connect output terminals of the plurality of sensing read circuits to an input terminal of an analog-to-digital converter.

### BACKGROUND OF THE INVENTION

1. Field of the Invention

The present invention relates to a technology for processing a touch line signal of a touch screen, and more particularly, to a circuit for processing a touch line signal of a touch screen, which can reduce the number of elements of a sensing read circuit by processing a touch line signal using a charge sharing scheme.

2. Description of the Related Art

Recently, touch screens are frequently used as a user interface device. Touch screens are divided into a resistive film type, a capacitance type, an infrared type and an ultrasonic type, depending upon a panel type. A touch screen of the capacitance type has advantages in terms of high transmittance, durability and price, and thus, is widely used in a mobile phone, a portable terminal such as a personal digital assistant (PDA), a monitor, and a variety of electric appliances. Hereafter, the touch screen of the capacitance type will be described.

A user can issue a desired command by touching an optional point on a touch screen display device using a stylus pen or a finger. To this end, the touch screen display device includes, in addition to a plurality of pixels for displaying an image, a plurality of touch sensing elements for sensing the point which is touched by the user.

A gate signal and a data signal are applied to each pixel, and each touch sensing element senses a touch made by the user and outputs a resultant sensing signal. To this end, the touch screen display device a gate driving unit and a data driving unit for applying the gate signal and the data signal, and a touch line signal processing circuit for processing the output signal of each touch sensing element, which is to be outputted to a touch line.

FIG. 1 is a diagram illustrating a conventional circuit for processing a touch line signal of a touch screen.

Referring to FIG. 1, a conventional circuit 100 for processing a touch line signal of a touch screen includes a plurality of sensing read circuits 110_1 to 110_N, a switch unit 120, and an A/D converter 130 in order to detect whether a touch screen panel 300 is touched by detecting a change in the capacitance of a plurality of sensor capacitors C_{S1}, C_{S2}, . . . which are formed on the touch screen panel 300.

Parasitic capacitors C_{P1}, C_{P2}, . . . exist between peripheral pads of the sensor capacitors C_{S1}, C_{S2}, . . . , and ground terminals, respectively.

Among the plurality of sensing read circuits 110_1 to 110_N, the sensing read circuit 110_1 includes a sensing read-out unit 111_1 for reading a voltage charged in the first sensor capacitor C_{S1} formed on the touch screen panel 300, and an integrator 112_1 for generating a touch detection output voltage Vₒ₁ by integrating the charged voltage of the first sensor capacitor C_{S1}, which is transmitted from the sensing read-out unit 111_1.

The operation of the conventional circuit 100 for processing the touch line signal of the touch screen will be described below. First, a precharge switch SW_{PC} is turned on for a predetermined time in a precharge mode so that a supply voltage VDD is precharged in the first sensor capacitor C_{S1} through the precharge switch SW_{PC}.

Then, a read-out switch SW_{RO} is turned on for a predetermined time in a read-out mode so that a voltage charged in the first sensor capacitor C_{S1} is transmitted to the integrator 112_1 through the read-out switch SW_{RO}.

At this time, when the first sensor capacitor C_{S1} is touched on the touch screen panel 300 by a user, the distance between the electrode plates of the first sensor capacitor C_{S1} is reduced, resulting in a change in the capacitance thereof. Therefore, the voltage transmitted from the first sensor capacitor C_{S1} to the integrator 112_1 changes (e.g., drops).

The integrator 112_1 integrates the voltage input through the read-out switch SW_{RO} to generate the touch detection output voltage Vₒ₁. The touch detection output voltage Vₒ₁ of the integrator 112_1 corresponds to a value obtained by dividing the amount of input charge by a capacitance value of an integrator capacitor Cᵢ. That is, an integration value of a touch line current is the amount of output charge.

As described above, the conventional circuit for processing the touch line signal of the touch screen uses an absolute value comparison scheme in which the voltage of the first sensor capacitor C_{S1} connected to one touch line is compared with a reference voltage V_{ref} by an operational amplifier OP of the integrator 112_1, and the touch detection output voltage Vₒ₁ is determined according to the comparison result.

The touch detection output voltage Vₒ₁ for one touch line is generated by the one sensing read circuit 110_1 through the above-described process, and touch detection output voltages Vₒ₂-V_{oN} for the other touch lines are generated by the sensing read circuits 110_2 to 110_N in the same manner.

The switch unit 120 includes N switches SW₁ to SW_{N} corresponding to the number of the sensing read circuits 110_1 to 110_N, and sequentially turns on the switches SW₁ to SW_{N} to sequentially transmit the touch detection output voltages Vₒ₁-V_{oN}, which are output from the sensing read circuits 110_1 to 110_N, to the A/D converter 130.

The A/D converter 130 converts the analog touch detection output voltages Vₒ₁-V_{oN}, which are input through the above-described process, into digital signals, and output the digital signals.

In the case of the conventional circuit for processing the touch line signal of the touch screen as described above, many integrators are necessary because the sensor capacitors are connected to the integrators in a one-to-one fashion, so that a large installation space is necessary, resulting in a significant increase in power consumption.

In addition, it may be difficult to measure the absolute value of capacitance and the sensor output voltages of the integrators may be changed by the parasitic capacitors.

### SUMMARY OF THE INVENTION

Accordingly, the present invention has been made in an effort to solve the problems occurring in the related art, and an object of the present invention is to provide a circuit for processing a touch line signal of a touch screen, in which sensing read circuits are formed in a differential structure and a charge sharing scheme is applied, so that one sensing read circuit can process a plurality of touch line signals.

In order to achieve the above object, according to one aspect of the present invention, there is provided a circuit for processing a touch line signal of a touch screen includes: a plurality of sensing read circuits including sensing read-out units, which are configured to precharge a first sensor capacitor and a second sensor capacitor formed on a touch screen panel with a ground voltage and a supply voltage, allow charges charged in the first sensor capacitor and the second sensor capacitor to be shared, and read-out a charge sharing result obtained by allowing the charges of the first sensor capacitor and the second sensor capacitor to be shared, and integrators configured to integrate output voltages of the sensing read-out units; and a switch unit configured to sequentially connect output terminals of the plurality of sensing read circuits to an input terminal of an analog-to-digital converter.

### BRIEF DESCRIPTION OF THE DRAWINGS

The above objects, and other features and advantages of the present invention will become more apparent after a reading of the following detailed description taken in conjunction with the drawings, in which:

FIG. 1 is a diagram illustrating a conventional circuit for processing a touch line signal of a touch screen;

FIG. 2 is a diagram illustrating a circuit for processing a touch line signal of a touch screen in accordance with an embodiment of the present invention; and

FIG. 3 is a timing diagram illustrating the operation of a circuit for processing a touch line signal of a touch screen in accordance with an embodiment of the present invention.

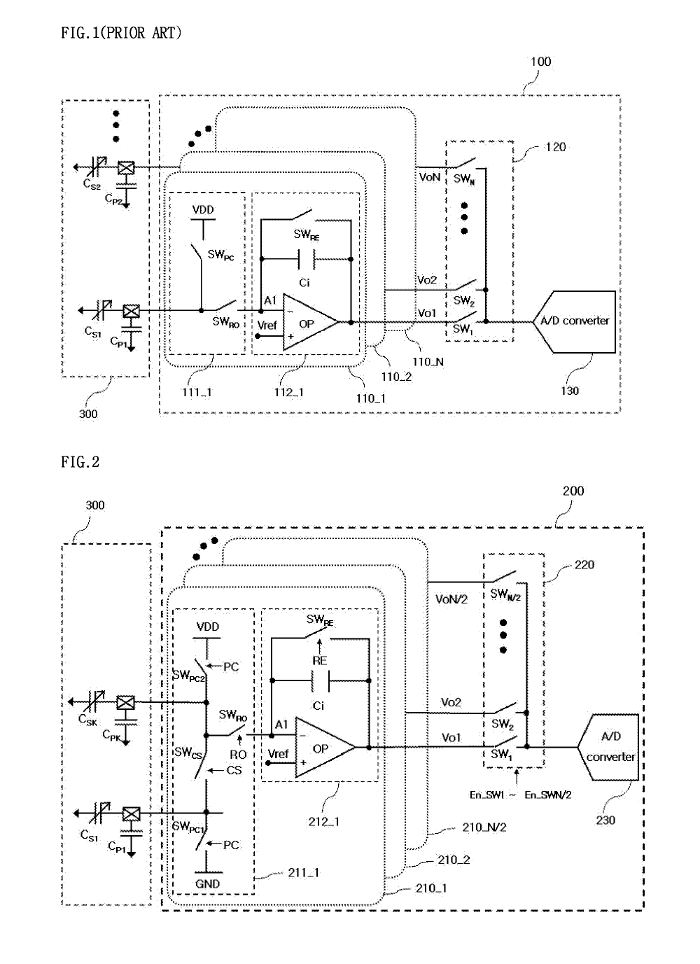

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

FIG. 2 is a diagram illustrating a circuit for processing a touch line signal of a touch screen in accordance with an embodiment of the present invention.

Referring to FIG. 2, a circuit 200 for processing a touch line signal of a touch screen in accordance with the embodiment of the present invention includes a plurality of sensing read circuits 210_1 to 210_N/2, a switch unit 220, and an A/D converter 230 in order to detect whether a touch screen panel 300 is touched by detecting a change in the capacitance of a plurality of sensor capacitors C_{S1}, C_{S2}, . . . , which are formed on the touch screen panel 300.

Among the plurality of sensing read circuits 210_1 to 210_N/2, the sensing read circuit 210_1 includes a sensing read-out unit 211_1 and an integrator 212_1 to generate a touch detection output voltage Vₒ₁ by detecting a change in the capacitance of the first sensor capacitor C_{S1} and the second sensor capacitor C_{SK}.

That is, the sensing read circuits 210_1 to 210_N/2 are formed in a differential structure and the one sensing read circuit 210_1 processes two pieces of touch data through the first sensor capacitor C_{S1} and the second sensor capacitor C_{SK}, so that the number of the sensing read circuits 210_1 to 210_N/2 is reduced to ½ of the number N of the conventional sensing read circuits.

When the first sensor capacitor C_{S1} is formed on one of a plurality of touch lines arranged on the touch screen panel 300 in a vertical or horizontal direction, the second sensor capacitor C_{SK} is preferably positioned adjacent to the touch line on which the first sensor capacitor C_{S1} is formed.

The sensing read-out unit 211_1 includes a first precharge switch SW_{PC1}, a second precharge switch SW_{PC2}, a charge sharing switch SW_{CS}, and a read-out switch SW_{RO}.

The first precharge switch SW_{PC1} has a first terminal connected to a ground voltage GND and a second terminal connected to one terminal of the first sensor capacitor C_{S1}, and precharges the first sensor capacitor C_{S1} with the ground voltage GND.

The second precharge switch SW_{PC2} has a first terminal connected to a supply voltage VDD and a second terminal connected to one terminal of the second sensor capacitor C_{SK}, and precharges the second sensor capacitor C_{SK} with the supply voltage VDD.

The charge sharing switch SW_{CS} has a first terminal connected to the second terminal of the first precharge switch SW_{PC1} and a second terminal connected to the second terminal of the second precharge switch SW_{PC2}, and allows charges of the precharged first sensor capacitor C_{S1} and the precharged second sensor capacitor C_{SK} to be shared.

The read-out switch SW_{RO} has a first terminal connected to a common node between the first sensor capacitor C_{S1} and the second sensor capacitor C_{SK} and a second terminal connected to an input terminal of the integrator 212_1, and reads out a result, which is obtained by allowing the charges of the first sensor capacitor C_{S1} and the second sensor capacitor C_{SK} to be shared, to transmit the result to the integrator 212_1.

The integrator 212_1 integrates the charge sharing result transmitted from the sensing read-out unit 211_1 to generate the touch detection output voltage Vₒ₁.

The integrator 212_1 includes an operational amplifier OP, an integrator capacitor Cᵢ, and a reset switch SW_{RE}. The operational amplifier OP has an inverted input terminal (−) to which the charge sharing result transmitted from the sensing read-out unit 211_1 is input, and a non-inverted input terminal (+) to which a reference voltage V_{ref} is input. The integrator capacitor Cᵢ has a first terminal connected to an output terminal of the operational amplifier OP and a second terminal connected to the non-inverted input terminal (+). The reset switch SW_{RE} is connected in parallel to the integrator capacitor Cᵢ to reset the integrator capacitor Cᵢ.

The switch unit 220 includes a plurality of switches SW₁ to SW_{N/2}. The plurality of switches SW₁ to SW_{N/2} have first terminals connected to the output terminals of the plurality of the sensing read circuits 210_1 to 210_N/2, respectively, and second terminals connected to the input terminal of the AD converter 230.

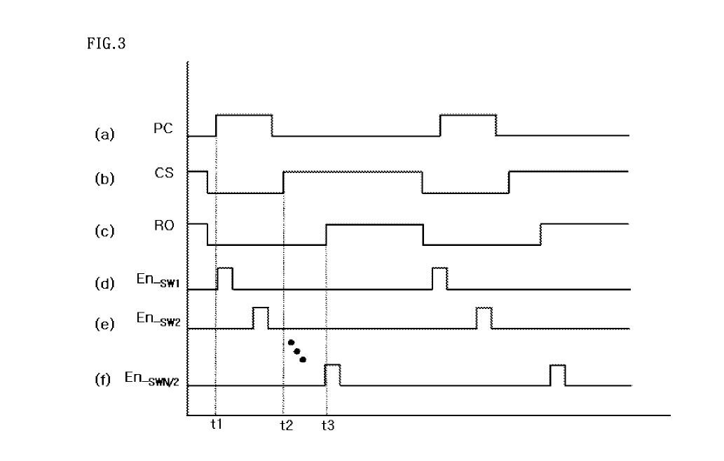

FIG. 3 is a timing diagram illustrating the operation of the circuit for processing the touch line signal of the touch screen in accordance with the embodiment of the present invention.

Hereinafter, the operation of the circuit for processing the touch line signal of the touch screen in accordance with the embodiment of the present invention will be described with referenced to FIGS. 2 and 3.

First, in a precharge mode, as illustrated in (a) of FIG. 3, a precharge control signal PC at a ‘high’ level is applied (t1) from a system controller (not shown) to the first precharge switch SW_{PC1} and the second precharge switch SW_{PC2}, so that the first precharge switch SW_{PC1} and the second precharge switch SW_{PC2} are turned on.

Thus, one terminal of the first sensor capacitor C_{S1} is connected to the ground terminal, so that the first sensor capacitor C_{S1} is precharged with the ground voltage. At this time, a first parasitic capacitor C_{P1}, which exists between a connection pad of the first sensor capacitor C_{S1} and the ground, is also precharged with the ground voltage.

Simultaneously to this, the second sensor capacitor C_{SK} is connected to the power terminal and precharged with the supply voltage. At this time, a second parasitic capacitor C_{PK}, which exists between a connection pad of the second sensor capacitor C_{SK} and the ground, is also precharged with the supply voltage.

Next, in a charge sharing mode, as illustrated in (b) of FIG. 3, a charge sharing control signal CS at a ‘high’ level is applied (t2) from the system controller to the charge sharing switch SW_{CS}, so that the charge sharing switch SW_{CS} is turned on. Thus, charges precharged in the first sensor capacitor C_{S1} and the first parasitic capacitor C_{P1} and charges precharged in the second sensor capacitor C_{SK} and the second parasitic capacitor C_{PK} are shared, wherein the total amount Q_{T1} of the charges is expressed by Equation 1 below.

Q_{T1}=(C_{SK}+C_{PK})·VDD+(C_{S1}+C_{P1})·0 Equation 1

Then, in a read-out mode, as illustrated in (c) of FIG. 3, a read-out sharing control signal RO at a ‘high’ level is applied (t3) from the system controller to the read-out switch SW_{RO}, so that the read-out switch SW_{RO} is turned on. Thus, charges changed by a touch operation after the charge sharing are charged in the integrator capacitor Cᵢ, wherein the amount of the charges is expressed by Equation 2 below.

Q_{Ci}=[(C_{SK}−C_{S1})+(C_{PK}−C_{P1})]·VDD/2 Equation 2

As expressed by Equation 2, since charges charged in the first and second parasitic capacitor C_{P1} and C_{PK} are offset, if they have charge values similar to each other, it is possible to ignore the influence by them.

Then, the integrator 212_1 integrates the voltage charged in the integrator capacitor Cᵢ to output the output voltage Vₒ₁, wherein the output voltage Vₒ₁ is expressed by Equation 3 below. The reset switch SW_{RE} in the integrator 212_1 is used to reset a previous voltage charged in the integrator capacitor Cᵢ before the integration.

Vₒ₁=Q_{Ci}/Cᵢ Equation 3

As described above, the embodiment of the present invention uses a relative comparison scheme in which a voltage according to the amount of changed charges of the pair of the sensor capacitors C_{S1} and C_{SK} connected to the touch lines adjacent to each other is compared with the reference voltage V_{ref} by the operational amplifier OP of the integrator 212_1, and the touch detection output voltage Vₒ₁ is determined according to the comparison result.

That is, according to the circuit for processing the touch line signal of the touch screen in accordance with the embodiment of the present invention, it is not necessary to detect an absolute value of capacitance, and the amount of charges varying depending on a change in the capacitance of the pair of the sensor capacitors C_{S1} and C_{SK} is measured using a specific voltage, so that it is possible to detect whether the touch screen panel is touched.

For example, when the first sensor capacitor C_{S1} is touched by a user, the distance between the electrode plates of the first sensor capacitor C_{S1} is reduced, resulting in a change in the capacitance thereof. Therefore, a relatively low voltage is output from the sensing read out unit 211_1 through the above-described precharge, charge sharing and read-out processes, as compared with the case in which a touch is not performed. At this time, the operational amplifier OP of the integrator 212_1 compares the low voltage input through the inverted input terminal thereof with the reference voltage V_{ref} and outputs the touch detection output voltage Vₒ₁ at a ‘high’ level according to the comparison result.

In another example, when the second sensor capacitor C_{SK} is touched by a user, the distance between the electrode plates of the second sensor capacitor C_{SK} is reduced, resulting in a change in the capacitance thereof. Therefore, a relatively high voltage is output from the sensing read out unit 211_1 through the above-described precharge, charge sharing and read-out processes, as compared with the case in which a touch is not performed. At this time, the operational amplifier OP of the integrator 212_1 compares the high voltage input through the inverted input terminal thereof with the reference voltage V_{ref}, and outputs the touch detection output voltage Vₒ₁ at a ‘low’ level according to the comparison result.

However, when any one of the first and second sensor capacitors C_{S1} and C_{SK} is not touched, the high or low voltage is not output from the sensing read out unit 211_1 through the above-described precharge, charge sharing and read-out processes. At this time, the operational amplifier OP of the integrator 212_1 compares the voltage input through the inverted input terminal thereof with the reference voltage V_{ref}, and outputs a preset voltage, for example, a voltage having a level equal to the level of the reference voltage V_{ref}, as the touch detection output voltage Vₒ₁ according to the comparison result.

Meanwhile, in a switch enable mode, as illustrated in (d) to (f) of FIG. 3, the switches SW₁ to SW_{N/2} corresponding to the number N/2 of the N/2 sensing read circuits 210_1 to 210_N/2 are sequentially turned on by switch enable signals En_{—}_{^{SW1}} to En₁₃ _{^{SWN/2}}, so that touch detection output voltages Vₒ₁ to V_{oN/2} are sequentially transmitted to the A/D converter 230.

The A/D converter 230 converts the analog touch detection output voltages Vₒ₁ to V_{oN/2} input through the above-described process into digital signals, and outputs the digital signals.

The system controller (not shown) recognizes a vertical coordinate of a point touched on the touch screen panel based on the digital signals output from the A/D converter 230, and recognizes a horizontal coordinate based on signals detected through gate lines or separately installed horizontal lines, thereby determining vertical and horizontal touch coordinates.

For example, in the case in which 100 gate lines and 100 touch lines are provided on the touch screen panel, when a changed vertical coordinate signal is output from a sensing read circuit connected to a 30^{th} touch line and a signal is applied to a 50^{th} gate line, an X axis coordinate is 50 and a Y axis coordinate is 30. That is, a point at which the 50^{th} gate line crosses the 30^{th} touch line is determined as a touch area.

Since the first sensor capacitor C_{S1} and the second sensor capacitor C_{SK} are connected to the touch lines adjacent to each other as described above, it is possible to obtain a more accurate touch sensing result when a K value for determining the distance therebetween is appropriately set.

This is because the adjacent touch lines may be simultaneously touched by a one-time touch operation when the K value is set to be very small, and a touch operation may not be detected when the K value is set to be very large.

In this regard, it is preferable to set the K value as an appropriate value through a sufficient experimental process when designing the touch screen panel.

As is apparent from the above description, in the circuit for processing the touch line signal of the touch screen in accordance with the embodiment of the present invention, sensing read circuits are formed in a differential structure and a charge sharing scheme is applied, so that one sensing read circuit can process two pieces of touch data, resulting in the reduction of power consumption and a chip area.

In addition, since the embodiment of the present invention uses a relative comparison scheme in which relative capacitance values of a pair of sensor capacitors are measured and compared with each other to detect whether a touch is performed, it is not insensitive to the absolute value of capacitance and it is possible to remove the influence by parasitic capacitors by allowing capacitance values by the parasitic capacitors to be offset.

Although a preferred embodiment of the present invention has been described for illustrative purposes, those skilled in the art will appreciate that various modifications, additions and substitutions are possible, without departing from the scope and the spirit of the invention as disclosed in the accompanying claims.

What is claimed is:

1. A circuit for processing a touch line signal of a touch screen comprising:
a plurality of sensing read circuits including sensing read-out units, which are configured to precharge a first sensor capacitor and a second sensor capacitor formed on a touch screen panel with a ground voltage and a supply voltage, allow charges charged in the first sensor capacitor and the second sensor capacitor to be shared, and read-out a charge sharing result obtained by allowing the charges of the first sensor capacitor and the second sensor capacitor to be shared, and integrators configured to integrate output voltages of the sensing read-out units; and
a switch unit configured to sequentially connect output terminals of the plurality of sensing read circuits to an input terminal of an analog-to-digital converter.

2. The circuit according to claim 1, wherein the first sensor capacitor and the second sensor capacitor are formed on touch lines adjacent to each other on the touch screen panel.

3. The circuit according to claim 1, wherein each sensing read-out unit comprises:
a first precharge switch configured to precharge the first sensor capacitor with the ground voltage;
a second precharge switch configured to precharge the second sensor capacitor with the supply voltage;
a charge sharing switch configured to allow the charges charged in the precharged first sensor capacitor and the precharged second sensor capacitor to be shared; and
a read-out switch configured to read out the charge sharing result.

4. The circuit according to claim 3, wherein the first precharge switch has a first terminal connected to a ground voltage and a second terminal connected to one terminal of the first sensor capacitor, and the second precharge switch has a first terminal connected to a supply voltage and a second terminal connected to one terminal of the second sensor capacitor.

5. The circuit according to claim 3, wherein the charge sharing switch has a first terminal connected to a second terminal of the first precharge switch and a second terminal connected to a second terminal of the second precharge switch.

6. The circuit according to claim 3, wherein the read-out switch has a first terminal connected to a common node between the first sensor capacitor and the second sensor capacitor and a second terminal connected to an input terminal of the integrator.

7. The circuit according to claim 1, wherein the integrator is configured to output one of a first level voltage, a second level voltage, and a preset voltage between the first level voltage and the second level voltage according to whether the first sensor capacitor and the second sensor capacitor are touched.

8. The circuit according to claim 7, wherein the preset voltage is a reference voltage.
